(19) United States
(12) Patent Application Publication
(10) Pub. No.: US 2012/0274643 A1
(43) Pub. Date: Nov. 1, 2012

(54) ANNOUNCEMENT INFORMATION PRESENTATION SYSTEM, ANNOUNCEMENT INFORMATION PRESENTATION APPARATUS, AND ANNOUNCEMENT INFORMATION PRESENTATION METHOD

(75) Inventor: Akihiro TANAKA, Osaka (JP)

(73) Assignee: Panasonic Corporation, Osaka (JP)

(21) Appl. No.: 13/455,138

(22) Filed: Apr. 25, 2012

(30) Foreign Application Priority Data
Apr. 26, 2011 (JP) 2011-097795
Apr. 23, 2012 (JP) 2012-097509

(51) Int. Cl. G06T 11/00

(52) U.S. Cl. 345/467

(57) ABSTRACT

An announcement information presentation is provided that apparatus includes a reception part, a decision part and a display part. The reception part is configured to receive an operational status information from an operating system of a movable vehicle. The operating system is configured to store the operational status of the movable vehicle. The decision part is configured to decide which announcement information to be presented to a crew member based on the operational status information received by the reception part. The display part is configured to present to the crew member the announcement information decided by the decision part.

### CROSS-REFERENCE TO RELATED APPLICATIONS

This application claims priority under 35 U.S.C. §119 to Japanese Patent Application No. 2011-097795, filed on Apr. 26, 2011 and Japanese Patent Application No. 2012-097509, filed on Apr. 23, 2012. The entire disclosure of Japanese Patent Applications No. 2011-097795 and Japanese Patent Application No. 2012-097509 are hereby incorporated herein by reference.

### BACKGROUND

1. Field of the Invention

The present invention relates to a passenger service used on a movable vehicle, and more particularly relates to an announcement information presentation system, an announcement information presentation apparatus, and an announcement information presentation method for assisting crew member in announcements on an aircraft.

2. Background Information

Along with developments recent years with moving vehicles, and particularly in the airline industry with aircraft, numerous airline companies have expanded operations to include not only domestic flights but also international flights, and complex airline networks have arisen that crisscross between various countries. A benefit to passengers is that they now have more choices for going to other countries.

In the past, only certain airline companies flew limited routes with selected crew members, so there was not much problem in terms of giving passengers ordinary announcements and emergency instructions. However, with the plethora of airline companies in service today, and with the multitude of flight destinations available, a growing problem has been that the language ability of the crew members has been inadequate to reliably convey information to passengers.

This problem has been addressed by airline companies by preparing manuals containing set phrases in various languages. However, it is still nothing but a format that must be searched by a human whether it be a paper manual or an electronic manual, so there have been cases when the crew members take the inappropriate responses to passengers.

For example, there have been instances of the wrong announcement being given at departure, such as “Thank you for flying with us today. We look forward to serving you again soon.” While such mistakes in selecting the greeting do not constitute a serious problem, if an erroneous announcement is similarly given in the event of an emergency, this can put the passengers at risk or cause them unnecessary anxiety, and in a worst case could even lead to a serious accident.

Also, even when there is no emergency, announcements are sometimes given to passengers in various languages, such telling them about the conditions around the aircraft.

In such a case, if the native language of the crew members is displayed matching the announcement language, the content of the announcement can be checked in the native language so that mistaken announcements will not go out.

Also, Japanese Laid-Open Patent Application H10-185609 (hereinafter referred to as “Patent Literature 1”) is an example of outputting the native language to match a foreign language.

Patent Literature 1 discusses a portable information device that includes a information output part and a displaying and outputting audio part. The information output part finds its own position by GPS or the like and outputs nearby sightseeing information and so forth stored in relation to its own position. The displaying and outputting audio part displays and outputs audio nearby sightseeing information in foreign languages to match the native language of the travelers.

With this system, when a traveler is at a sightseeing location, for example, if information displayed according to that place is selected hierarchically on the display screen of a portable information device, the conversation text will be displayed in the native language, and when a selector switch is pressed, the conversation text is changed to the local language and also be outputted as audio.

This allows the wishes of various kinds of traveler to be conveyed to local people.

### SUMMARY

If the invention discussed in Patent Literature 1 is applied to the announcements given by crew members on an aircraft, when crew members select announcements related to the current flight location of the aircraft in the native language, the content in the language for announcement is also displayed. Therefore, there is no chance that the wrong content will be announced if the crew members speak from this content while announcing.

Nevertheless, the above-mentioned Patent Literature 1 merely involves displaying set phrases according to the location, and the content cannot be changed flexibly to accommodate the situation in the event of an emergency or the like.

For example, when an aircraft is flying close to Mount Fuji, a set phrase such as “Mount Fuji will be visible on the right-below momentarily” can be displayed in both the native language and the corresponding foreign language for announcement. However, if at that time turbulence is expected due to the weather or to the proximity of Mount Fuji, it will be difficult to deal with situations in which the crew wants to make an announcement that cannot be put into a set phrase, such as “Mount Fuji will be visible on the right-below momentarily, but we may encounter some turbulence, so please fasten your seatbelts,” instantly and appropriately in a foreign language at which the crew members are not adept at the foreign language for announcement.

Accordingly, there is the risk that the opportunity to make the announcement may be missed. In the event of an emergency, this can have serious repercussions.

One object of the technology disclosed herein is to provide an announcement information presentation system, an announcement information presentation apparatus, and an announcement information presentation method in which the appropriate announcement can easily be changed according to the operational status of a movable vehicle.

To solve the stated problem, an announcement information presentation apparatus is provided that includes a reception part, a decision part and a display part. The reception part is configured to receive operational status information from an operating system of a movable vehicle. The operating system is configured to store the operational status information of the movable vehicle. The decision part is configured to decide which announcement information to be presented to a crew member based on the operational status information received by the operational status reception part. The display part is configured to present to the crew member the announcement information decided by the decision part.

These and other objects, features, aspects and advantages of the present invention will become apparent to those skilled in the art from the following detailed description, which, taken in conjunction with the annexed drawings, discloses a preferred and other example embodiments of the present invention.

### BRIEF DESCRIPTION OF DRAWINGS

Referring now to the attached drawings which form a part of this original disclosure:

FIG. 1 is a diagram of the main components of an announcement information presentation system in First Embodiment of the present invention;

FIG. 2 is a table showing examples of aircraft operational status information for this same announcement information presentation system;

FIG. 3 is a flowchart of the processing performed by the presented information decision part in this same announcement information presentation system;

FIG. 4 is a table showing examples of the database of presented information in this same announcement information presentation system;

FIG. 5 is a diagram of the main components of an announcement information presentation system in Second Embodiment of the present invention; and

FIG. 6 is a table showing examples of information definitions in this same announcement information presentation system.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

The announcement information presentation system disclosed herein below will be discussed as applied to the operation of an aircraft as a movable vehicle.

### First Embodiment

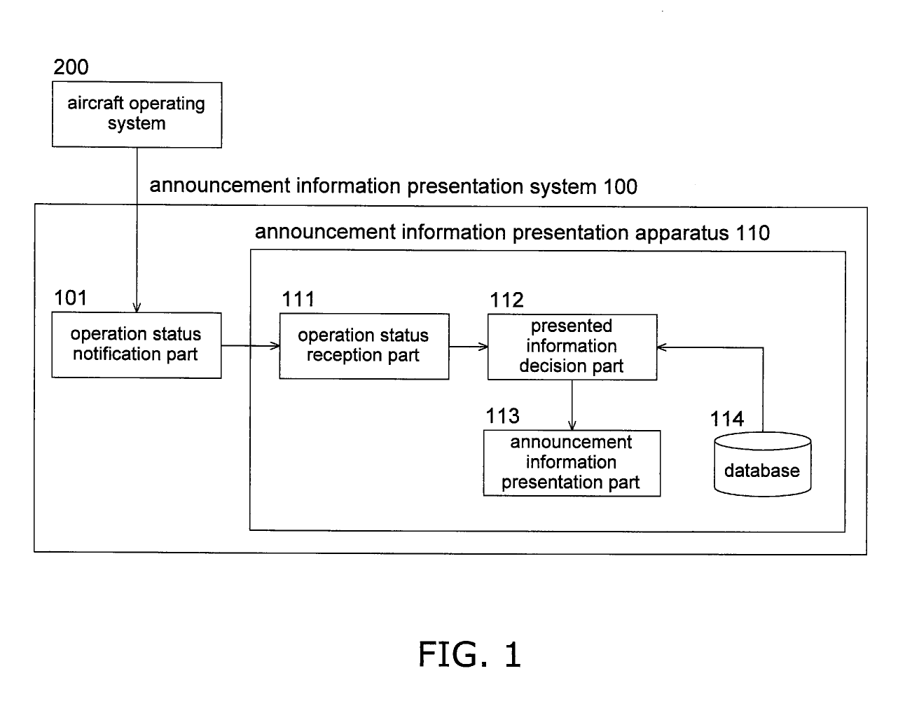

FIG. 1 is a diagram of the main components of an announcement information presentation system in First Embodiment of the present invention. The announcement information presentation system 100 shown in FIG. 1 acquires information related to the current operational status of an aircraft from an aircraft operating system 200, and presents suitable announcement information to an announcement information presentation apparatus 110 on the basis of the acquired information.

In First Embodiment, it is assume that the announcement information presentation system 100 and the aircraft operating system 200 are installed in the aircraft. However, the announcement information presentation system 100 and the aircraft operating system 200 are independent from each other, and are connected via an operational status notification part 101 (one example of a notification part)(discussed below).

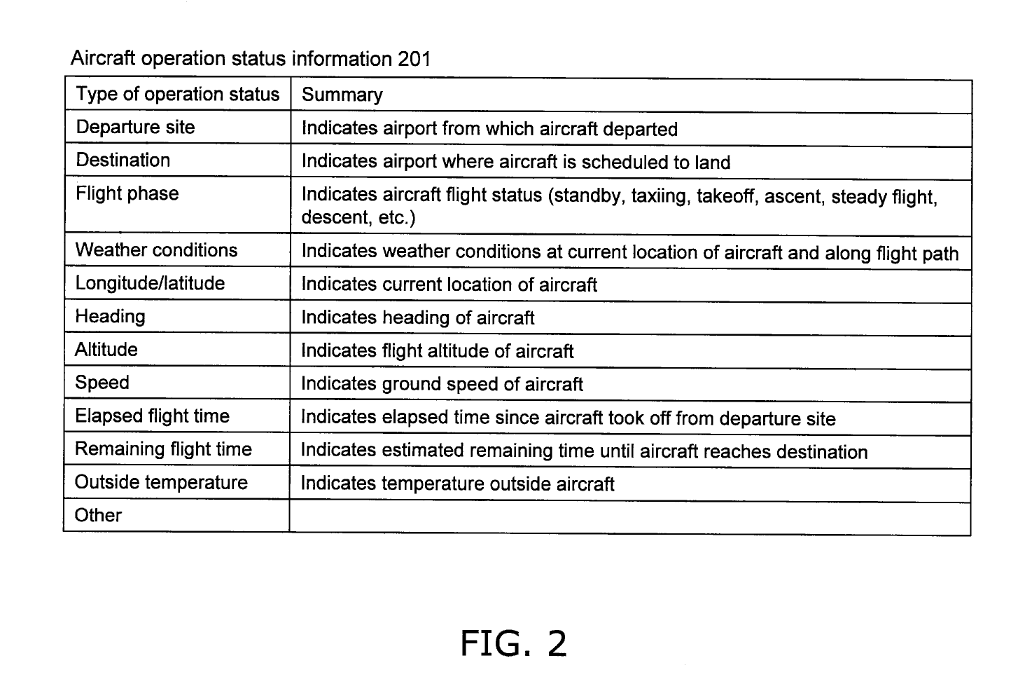

The aircraft operating system 200 usually stores the information shown in FIG. 2 as aircraft operational status information 201. For example, this might include “departure site,” which indicates the airport from which the aircraft departed, “flight phase,” which indicates the flight status of the aircraft (standby, taxiing, takeoff, ascent, steady flight, descent, etc.), or “weather conditions,” which indicates the weather conditions on the current location along the flight path of the aircraft.

With the announcement information presentation system 100 in First Embodiment, the information shown in FIG. 2 is sent through the operational status notification part 101 to an operational status reception part 111 (one example of a reception part) of the announcement information presentation apparatus 110. This notification may be accomplished by wired or wireless communication.

The announcement information presentation apparatus 110 may be a portable terminal that is carried by each of the crew members, or may be a stationary terminal installed for use only by crew members.

When aircraft operational status information 201 is received by the operational status reception part 111, the announcement information presentation apparatus 110 sends the received information to a presented information decision part 112 (one example of a decision part).

The presented information decision part 112 decides the information to be presented to the crew members on the basis of the received aircraft operational status information 201 and a database 114. The database 114 and the specific method for deciding will be discussed below.

When the presented information to be presented is decided by the presented information decision part 112, this presented information is sent to an announcement information display part 113 (one example of a display part), and is presented as announcement information in a form that can be understood by the crew members.

A variety of presentation methods is possible with the announcement information display part 113, such as presenting to the crew members by audio or presenting to the crew members by screen display, but any presentation method may be employed by the announcement information display part 113. This announcement information display part 113 may be a display that is built into a wall of the craft, or the portable terminal of the crew members.

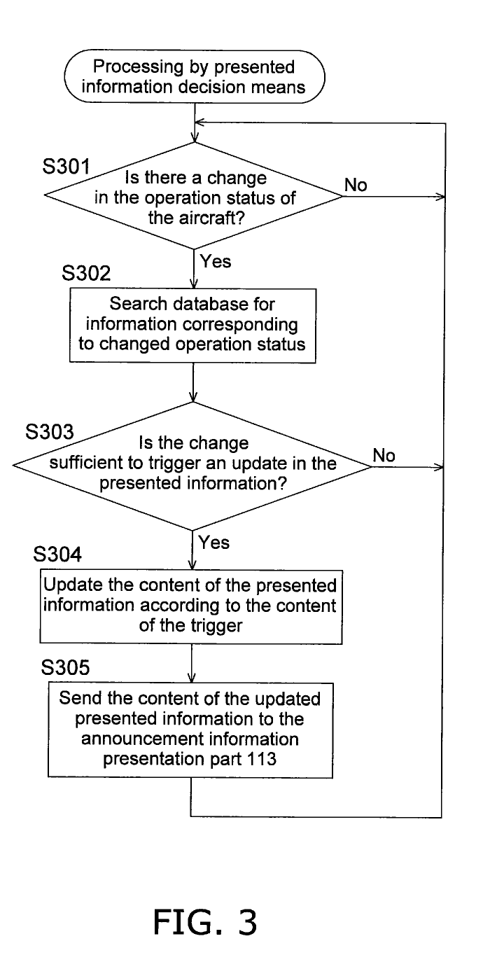

The procedure by which the presented information decision part 112 of the announcement information presentation apparatus 110 decides the information to be presented by the announcement information display part 113 will now be described through reference to FIG. 3.

FIG. 3 is a flowchart of the operation of the presented information decision part 112. As shown in FIG. 3, when a change in the operational status of the aircraft is detected by the presented information decision part 112 on the basis of the aircraft operational status information 201 received from the aircraft operating system 200 via the operational status notification part 101 and the operational status reception part 111 (step S301), the presented information decision part 112 searches the database 114 on the basis of this change (step S302).

As a result of searching the database 114, it is determined whether or not this change is sufficient to trigger an update in the presented information (step S303), and if it is determined that the change is indeed sufficient to trigger an update in the presented information, the content of the presented information is updated according to this change (step S304), and the updated presented information is sent to the announcement information display part 113 (step S305).

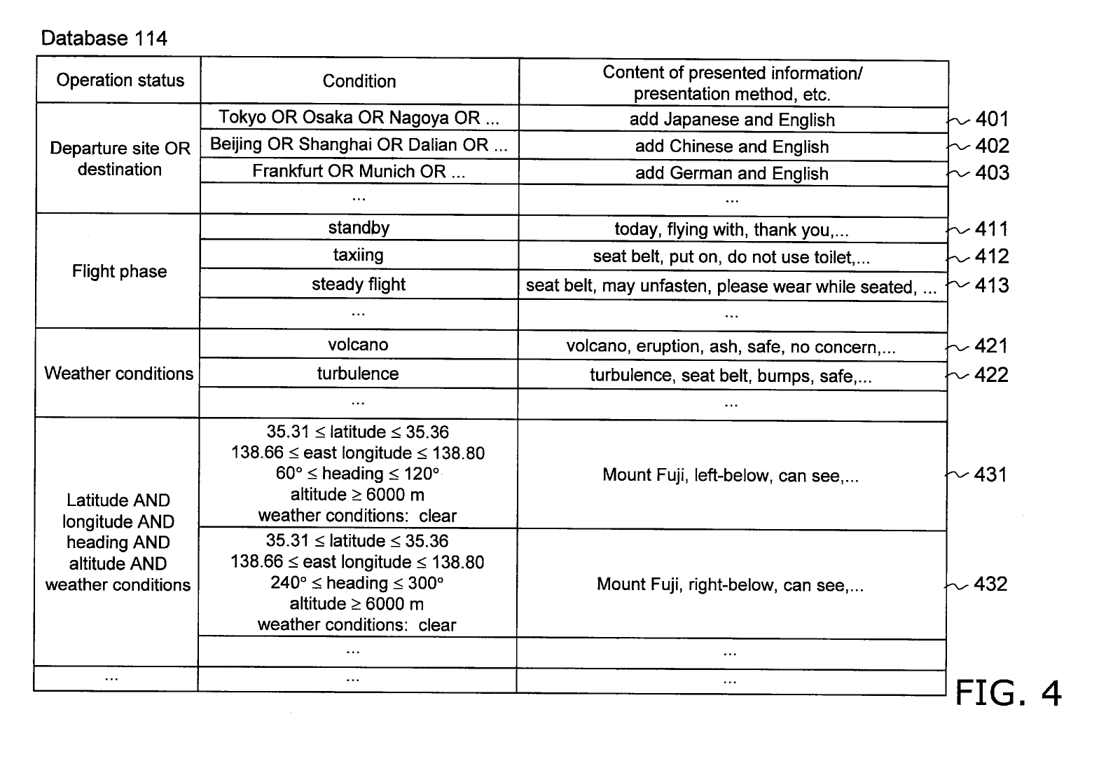

FIG. 4 shows examples of the database 114. This table will be used to describe the details of the processing performed in steps S302 and S303.

Operational status information of the aircraft and presented information for the crew member to make the announcement are bound and stored in the database 114.

With the database 114, in presented information 401 to 403, conditions are defined for deciding the language of presentation according to the departure site or the destination.

With the presented information 401, if the departure site or destination is Tokyo, Osaka, Nagoya, etc., then a message is given to the effect that Japanese and English are to be selected as the presented languages in the announcement information display part 113. Similarly, with the presented information 402, if the departure site or destination is Beijing, Shanghai, etc., then a message is given to the effect that Chinese and English are to be selected as the presented languages in the announcement information display part 113. With the presented information 403, if the departure site or destination is Frankfurt, Munich, etc., then a message is given to the effect that German and English are to be selected as the presented languages to the announcement information display part 113.

Since information about the departure site and destination is decided for each flight, the presented information 401 to 403 will be hit in the search in step S302 (FIG. 3) only once at the start of the flight. Accordingly, the language information presented to the announcement information display part 113 will be decided at the start of the flight, after which it will not change during the flight.

For example, on a flight from Tokyo to Beijing, a message indicating that the departure site is Tokyo is sent from the operational status reception part 111 to the presented information decision part 112 at the start of the flight, and the presented information decision part 112 searches the database 114 in step S302. As a result, the presented information 401 is hit (FIG. 4), and Japanese and English are decided as the presented languages in the announcement information display part 113.

Similarly, since the destination is Beijing, the presented information 402 is hit (FIG. 4), and Chinese and English are decided as the presented languages to the announcement information display part 113.

As a result, the presented information 401 and 402 are combined so that the final presented languages are Japanese, Chinese, and English.

In the example shown in FIG. 4, presented information 411 to 413 are categories defining the presented information according to the flight phase. The presented information 411 represents the phase during standby prior to departure, and defines messages presenting words and phrases related to welcome greetings used during this state, such as “today,” “flying with us,” “thank you,” and other such information.

On a flight from Tokyo to Beijing, as mentioned above, words and phrases in Japanese and Chinese corresponding to the above English words are also presented.

The presented information 412 and 413 also define words and phrases suitable for taxiing and suitable for steady flight, respectively. Similarly, presented information 421 and 422 defines words and phrases suitable for discussing weather conditions.

For example, in a situation that almost never comes up, such as the eruption of a volcano, it is conceivable that the crew members will have a very difficult time giving instructions outside their native language, so a wide variety of cases related to volcanoes may be registered as a vocabulary database, as shown by the presented information 421. Consequently, when the crew members are making announcements, they can choose from among these words and phrases those words that are required by the announcement, and can easily create an announcement test outside of their native language, so the job of the crew members is greatly facilitated.

The definitions of presented information 431 and 432 are an example of a case in which a plurality of conditions are linked by AND. For example, the presented information 431 and 432 in FIG. 4 are definitions of presented information decided by factoring in latitude, longitude, heading, altitude, and weather conditions.

The presented information 431 defines information presented when the weather is clear, the aircraft is flying east on the south side of Mount Fuji, close enough that Mount Fuji is visible, and at an altitude of at least 6000 meters.

The presented information 432 provides similar definitions, but differs from the presented information 431 in that the heading is west. Accordingly, under the conditions of the presented information 431, information indicating the left-below is presented, but when the conditions of the presented information 432 are satisfied, the definition is to present information indicating the right-below.

Consequently, just as with the presented information 421, when an aircraft flying east at a latitude of 35.33 degrees crosses the east longitude of 138.66, the condition in step 5303 (FIG. 3) becomes “Yes,” suitable information such as “Mount Fuji,” “ left-below,” “you can see,” and so forth is presented by the announcement information display part 113 at the proper timing and in the required language, and the crew can refer to this to easily make an announcement in a foreign language.

### Second Embodiment

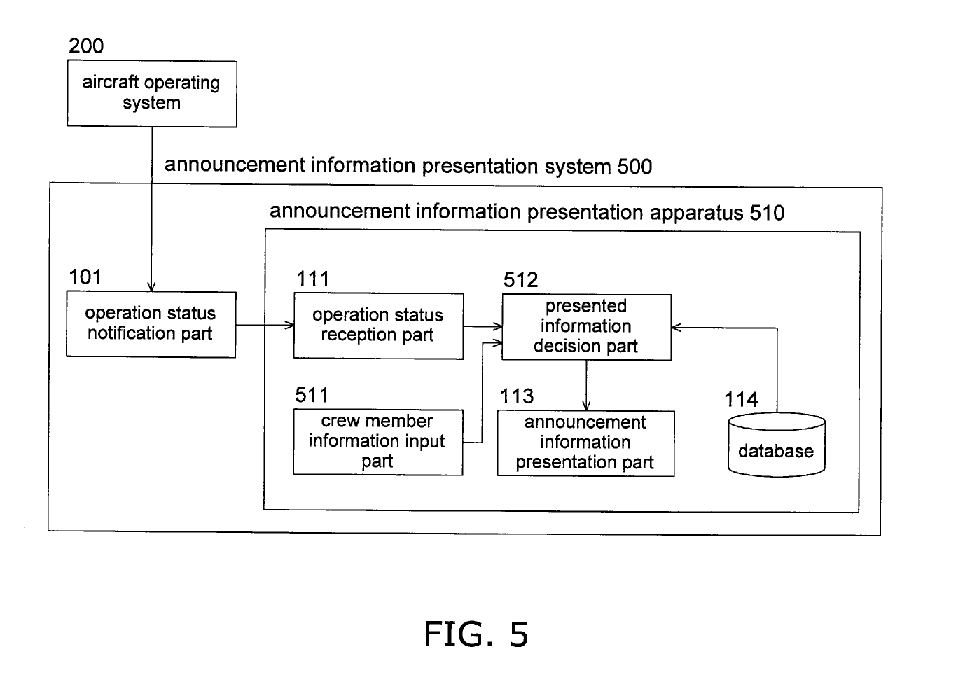

FIG. 5 is a diagram of the main components of an announcement information presentation system in Second Embodiment of the present invention. Second Embodiment differs from First Embodiment in that a crew member information input means 511 (one example of an information input part) is added to an announcement information presentation apparatus 510, and in that the presented information is decided by a presented information decision part 512 using not just the aircraft operational status information 201 and the information in the database 114, but also the information of the crew member information input means 511.

Second Embodiment will now be described, focusing on the differences from First Embodiment. Those components that are the same as in First Embodiment will be numbered the same and not described again.

With the announcement information presentation system 500 of Second Embodiment, the information shown in FIG. 2 of First Embodiment is sent to the operational status reception part 111 of the announcement information presentation apparatus 510 via the operational status notification part 101. This notification may be accomplished by wired or wireless communication.

The announcement information presentation apparatus 510 may be a portable terminal that is carried by each of the crew members, or may be a stationary terminal installed for use only by crew members.

When aircraft operational status information 201 is received by the operational status reception part 111, the announcement information presentation apparatus 510 sends the aircraft operational status information 201 to the presented information decision part 512.

The presented information decision part 512 decides the information to be presented to the crew members on the basis of the received aircraft operational status information 201 and the database 114.

When the information to be presented is decided by the presented information decision part 512, this presented information is sent to the announcement information display part 113, and is presented by the announcement information display part 113 as announcement information in a form that can be understood by the crew members.

Just as in First Embodiment, a variety of presentation methods is possible, such as presenting to the crew members by audio or presenting to the crew members by screen display.

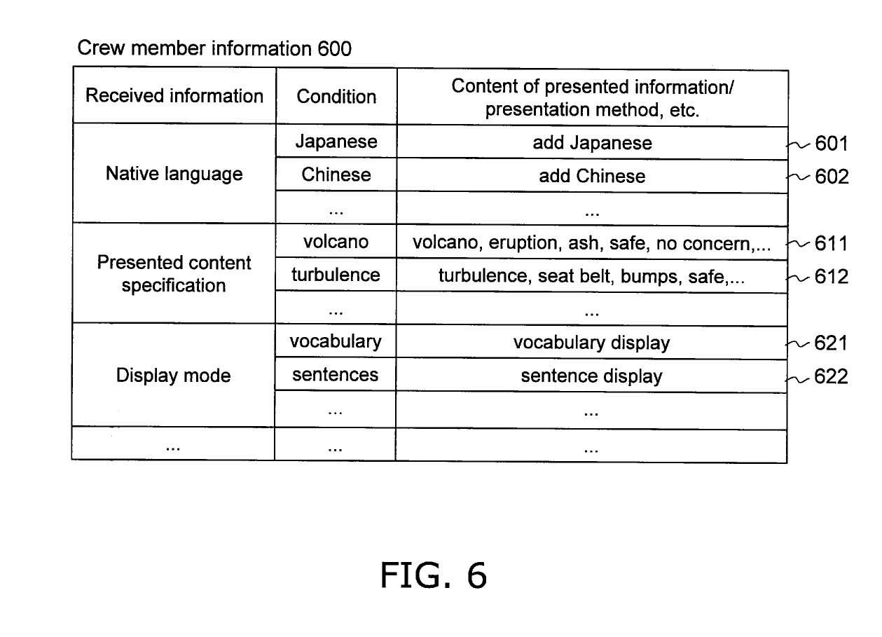

FIG. 6 is a table showing examples of crew member information 600 inputted from the crew member information input means 511. In FIG. 6, presented information 601 and 602 define the presented information when the native language of the crew members has been specified.

With the presented information 601, when it has been specified from the crew member information input means 511 that the native language of the crew members is Japanese, a definition is given to the effect that Japanese information will be added as the information presented by the announcement information display part 113, and similarly, with the presented information 602, when the native language of the crew members is Chinese, a definition is given to the effect that Chinese information will be added to the presented information. Consequently, when Japanese crew members are working on a flight from Beijing to Frankfurt, for example, Japanese is selected and inputted as the native language to the announcement information presentation apparatus 510, so that information is presented not only in Chinese and German, but also in Japanese, the advantage of which is that the presented information will be easier for the crew members to understand by contrasting the Japanese words with Chinese or German of the same meaning.

Presented information 611 and 612 are an example of when the crew members have specified the presentation content. For instance, even though there is actually no volcano or turbulence, if it is possible that this could occur, and if the crew wants to make an announcement related to a volcano or turbulence for the purpose of urging caution, the crew members can select the presentation content and can present related information to the announcement information display part 113.

The presented information 621 and 622 define the presentation method (whether to present as vocabulary or as sentences) according to the preferences and skill of the crew members. That is, if a crew member understands the grammar and so forth of a foreign language, he or she can create an announcement text from just vocabulary, but if the crew member can not smoothly create an announcement text from just vocabulary, he or she can make an announcement by selecting and combining a number of short phrases.

### Other Embodiments

(A) In First Embodiment, an example was given in which specific words were defined as information to be presented by the announcement information display part 113 when certain conditions were met, but rather than just words, specific phrases or an announcement text itself may be presented.

(B) In Second Embodiment, an example was given in which there was no definition of a user interface for crew members to input information to the crew member information input means 511, but any input method may be employed. For example, the crew members can select from a list of possible options on a screen, or the crew members can input commands by voice, or the announcement information presentation apparatus 510 can read biological information of the crew members, such as from fingerprints or an iris, and pre-registered information applied.

(C) In the above embodiments, an example was given in which an aircraft constituted the movable vehicle, but the technology disclosed herein can be applied to any moving vehicle in which crew members make announcements to passengers, such as a train or a ship.

(D) In the above embodiments, the announcement information presentation system 100 including the operational status notification part 101 was described, but the operational status notification part 101 merely sends information from the aircraft operating system 200 to the announcement information presentation apparatus 110, so as long as the operating status of the movable vehicle can be accurately conveyed from the outside, the announcement information presentation system 100 need not be equipped with the operational status notification part 101.

(E) In the above embodiments, a case was assumed in which the announcement information presentation system 100 was provided inside an aircraft, but this is not the only option. For example, the database 114 of the announcement information presentation system 100 may be provided outside the aircraft.

(F) In the above embodiments, the announcement information presentation apparatus 110 searched the database 114 on the basis of a change in the operational status of the aircraft when such a change was detected from the aircraft operational status information 201, but this is not the only option.

For example, the announcement information presentation apparatus 110 may be equipped with an interface (such as a button or a touch screen) for receiving commands from crew members to acquire the aircraft operational status information 201. In this case, the announcement information presentation apparatus 110 may acquire the aircraft operational status information 201 and search the database 114 according to the acquisition command inputted by a crew member.

Furthermore, the announcement information presentation apparatus 110 may also be equipped with an interface for receiving commands from crew members to search the database 114. In this case, the announcement information presentation apparatus 110 may search the database 114 according to the search command inputted by a crew member.

(G) Although not specifically mentioned in the above embodiments, the announcement information presentation apparatus 510 may display pronunciation information about the presented information along with the presented information. More specifically, when the announcement information presentation apparatus 510 displays presented information in Japanese, Chinese, and English on a flight from Tokyo to Beijing, the pronunciation of the Japanese presented information may be written out in Chinese and English, the pronunciation of the Chinese presented information may be written out in Japanese and English, and the pronunciation of the English presented information may be written out in Chinese and Japanese. This tells the crew members how to pronounce the presented information that is written in a foreign language.

Furthermore, when the native language of the crew members is specified in the crew member information 600, the announcement information presentation apparatus 510 may write out in the native language the pronunciation of presented information that is not displayed in the native language. Specifically, on a flight from Tokyo to Beijing, when Japanese is specified as the native language in the crew member information 600, the pronunciation of the Chinese and English presented information should be written out in Japanese. This tells the crew members how to pronounce the presented information that is deemed necessary, in their own native language.

(H) In the above embodiments, the aircraft operational status information 201 included the various information shown in FIG. 2, but the aircraft operational status information 201 should include at least position information (including latitude and longitude), and more preferably includes the flight phase and/or weather conditions.

Therefore, as long as the announcement information presentation apparatus 110 is able to display announcement information corresponding to position information, the announcement information may be displayed in one or more predetermined languages. Here again, announcements can be provided flexibly to suit the operational status.

### General Interpretation of Terms

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Accordingly, these terms, as utilized to describe the present invention should be interpreted relative to the announcement information presentation apparatus or relative to the announcement information presentation system.

The term “configured” as used herein to describe a component, section, or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. An announcement information presentation apparatus comprising:
a reception part configured to receive operational status information from an operating system of a movable vehicle, the operating system being configured to store operational status information that relates to the movable vehicle;
a decision part configured to decide which announcement information to be presented to a crew member based on the operational status information received by the reception part; and
a display part configured to present to the crew member the announcement information decided by the decision part.

2. The announcement information presentation apparatus according to claim 1, wherein
the decision part is configured to decide the language of the announcement information displayed by the display part based on the operational status information, and
the display part is configured to display the announcement information in the language decided based on the operational status information.

3. The announcement information presentation apparatus according to claim 1, further comprising:
a information input part configured to receive input information from the crew member, wherein
the decision part is configured to decide the announcement information based on the input information and the operational status information.

4. The announcement information presentation apparatus according to claim 3, wherein
the input information includes information relating to native language of the crew member,
the decision part is configured to decide a language of the announcement information displayed by the display part based on the input information, and
the display part is configured to display the announcement information in the language decided based on the input information.

5. The announcement information presentation apparatus according to claim 1, further comprising:
a database configured to bind and store the operational status information and the announcement information.

6. An announcement information presentation system, comprising:
the announcement information presentation apparatus according to claim 1; and
a notification part configured to receive operational status information from the operating system of the movable vehicle, the operating system being configured to store current operational status information of the movable vehicle, wherein
the reception part of the announcement information presentation apparatus being configured to receive the operational status information via the notification part.

7. An announcement information presentation method comprising:
receiving operational status information in a reception part from an operating system of a movable vehicle, the operating system being configured to store the operational status information of the movable vehicle;
deciding which announcement information to be presented to a crew member via a decision part based on the operational status information received by the reception part; and
presenting the announcement information to the crew member via a display part based on the decision of which announcement information to be presented.
